(19) United States
(12) Patent Application Publication
(10) Pub. No.: US 2006/0016627 A1
(43) Pub. Date: Jan. 26, 2006

(54) Bifurcated electrical vehicle motor

(76) Inventor: Harold Robertson, Mt. Vernon, NY (US)

Correspondence Address: ASHKAN NAJAFI, P.A., 6817 SOUTHPOINT PARKWAY, SUITE 2301, JACKSONVILLE, FL, 32216, US

(21) Appl. No.: 10/895,864

(22) Filed: Jul. 22, 2004

(51) Int. Cl. B60K 1/00

(52) U.S. Cl. 180/65.1

(57) ABSTRACT

A vehicle motor includes a plurality of in-line electric motors and a high-speed pulley system including a plurality of pulleys. The motor further includes a direct current mechanism and an alternating current mechanism for selectively supplying power and accelerating the vehicle. The alternating current mechanism includes primary and secondary circuits for adjusting the current and voltage level of the system. The alternating current mechanism further includes a high-energy variable-voltage transformer to convert variations of a first current in the primary circuit into variations of a voltage and a second current in the secondary circuit. The alternating current mechanism further includes an alternator for sending alternating current from the transformer to another of the plurality of motors. The motor further includes a mechanism for automatically regulating an operating mode of the system so that the alternating current mechanism is inactive when the direct current mechanism is active and vice versa.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a hybrid car engine and, more particularly, to a hybrid engine system including an automatic mechanism for switching between low and high powered electric motors.

2. Prior Art

There are basically four types of electric propulsion systems known for vehicles. First, there is a pure electric drive vehicle. The pure electric drive vehicle has an electric motor which receives power from a main battery pack via a controller. The controller controls the speed of the electric motor. The major disadvantage of a pure electric drive vehicle is that the range is very limited and the vehicle must be stopped and connected to an energy source such as an electrical outlet in order to be recharged.

The second type of electric propulsion system for vehicles is a series hybrid system. There are three major components in a series system: (1) a generator; (2) an electric motor arranged in series; and (3) an engine powering the generator. Mechanical energy generated by the engine is converted to electrical energy by the generator and is then converted back to mechanical energy by the electric motor. Each process of conversion is afflicted with losses and subsequent reductions of efficiency which is a significant disadvantage of this type of system.

The third type of electric propulsion systems is the parallel hybrid system, which generally has three component areas: (1) electrical storage mechanisms, such as storage batteries, ultracapacitors, or a combination thereof; (2) an electric drive motor, typically powered by the electrical storage mechanism and used to propel the wheels at least some of the time; and (3) an engine, such as a liquid fueled engine (e.g. internal combustion, stirling engine, or turbine engine) typically used to propel the vehicle directly and/or to recharge the electrical storage mechanism.

In parallel hybrid systems, the electric drive motor is alternatively driven by mechanically coupling it to the engine. When coupled, the engine propels the vehicle directly and the electric motor acts as a generator to maintain a desired charge level in the batteries or the ultracapacitor. While a parallel hybrid system achieves good fuel economy and performance, it must operate in an on and off engine parallel mode. In this mode, the stop-and-go urban driving uses electric power and the engine is used to supplement existing electric system capacity. For long trips, when the battery for the electric motor could be depleted, the vehicle cruises on the small engine and the electric system will provide the peaking power.

The primary advantage of the parallel hybrid drive over the series drive previously described is improved efficiency (lower fuel consumption) in the engine, since the engine's mechanical energy is passed directly on to the drive axle. The bulky generator is no longer required, thereby lowering both the cost and weight of the vehicle.

The fourth type of electric propulsion systems is the combined series-parallel hybrid system, which includes the advantages of both the series hybrid vehicle and the parallel hybrid vehicle. The combined series-parallel system also minimizes the disadvantages of both the series and parallel systems when taken separately.

The second, third and fourth systems described above have encountered space problems. The component parts were difficult to fit into a single vehicle, while allowing room for manufacture and subsequent maintenance work. The internal combustion engine and the electric motor have been squeezed into one end of the vehicle. Thus, hardware configurations have been fairly complex and bulky in the past. To provide additional space in some vehicles, manufacturers have reduced the size of the engines. This size reduction often accompanies a lower amount of power that the engine has to offer. The loss of power is counter productive to the industry's goal of increasing power in electric vehicles.

Like the typical electric cars, the hybrid cars are arranged so that auxiliary machineries, such as an air conditioner compressor, power-steering oil pump, negative-pressure pump for brake booster, etc., which are mounted in the vehicle, are driven by means of an auxiliary drive motor which is connected to the battery commonly used for the auxiliary drive motor and the vehicle drive motor. Accordingly, the available time for the battery is liable to be shortened so that the battery capacity becomes insufficient as the auxiliaries are driven. It is still difficult, therefore, for some hybrid cars, which are furnished with the motor-driven auxiliaries, to enjoy satisfactory cruising range and power performances. If the vehicle is furnished with the auxiliary drive motor, moreover, the vehicle is increased both in cost and in weight, and requires an additional space for this motor.

Recently, the regulations on exhaust gas from those vehicles which use an internal combustion engine as their drive source have been made more rigorous to tackle environmental pollution. In this respect, various new technologies have been developed. Electric cars, which use an electric motor as their drive source and produce no exhaust gas, should be ideal motor vehicles for reduction of the exhaust gas amount. Typical electric cars are designed so that a battery is used to supply the electric motor with electric power. Naturally, however, the available battery capacity for each vehicle is limited, so that the power performances are poorer and the cruising range is shorter than those of the vehicles which use the engine as the drive source. In order to make the electric cars more popular, these technical problems must be solved.

Overall, hybrid cars, which are furnished with a generator, driven by means of an internal combustion engine, for battery charging, are believed to be promising modern electric cars which can enjoy an extended cruising range.

Accordingly, a need remains for a hybrid car engine with increased efficiency that includes the above-mentioned advantages. The present invention satisfies such a need by providing a small gasoline-powered engine that is coupled to an electric motor. Such motors are powered directly, eliminating the need for a large battery bank. Additionally, the small design of the engine reduces fuel consumption thereby reducing harmful emissions.

### BRIEF SUMMARY OF THE INVENTION

In view of the foregoing background, it is therefore an object of the present invention to provide a bifurcated electrical vehicle motor. These and other objects, features, and advantages of the invention are provided by an electrical engine system for propelling a vehicle at variable speeds wherein the vehicle includes a magnetic clutch and a cooling fan provided with a condenser. Such a system includes a plurality of in-line electric motors including a plurality of cylinders arranged along a rectilinear path operably connected to selected portions of the vehicle respectively.

The present invention further includes a high-speed pulley system including a plurality of pulleys operably connected to the plurality of motors respectively and contemporaneously rotatable at variable speeds during operating conditions.

The present invention further includes a direct current mechanism for supplying power and accelerating the vehicle by direct current when the vehicle is traveling below a predetermined threshold speed. Such a low-voltage mechanism is connected to one motor and includes a deep cycle battery for supplying electric current to the system. The battery includes a plurality of evaporator coils traversing along therein and a plurality of pressure-relief valves disposed adjacent the evaporator coils wherein the pressure-relief valves are caused to open when the battery reaches a predetermined threshold pressure.

Advantageously, the present invention further includes an alternating current mechanism for selectively supplying power and accelerating the vehicle when the vehicle is traveling above a predetermined threshold speed. Such an alternating current mechanism is operably connected to another of the plurality of motors. The alternating current mechanism includes primary and secondary circuits for adjusting the current and voltage level of the system.

The alternating current mechanism preferably includes a high-energy variable-voltage transformer employing mutual induction to convert variations of a first current in the primary circuit into variations of a voltage and a second current in the secondary circuit. Furthermore, the alternating current mechanism further includes an alternator for producing and sending alternating current from the transformer to another of the plurality of motors.

The present invention further includes a mechanism for automatically regulating an operating mode of the system so that the alternating current mechanism is inactive when the direct current mechanism is active and vice versa. Such a regulating mechanism advantageously includes a governor attached to the vehicle for automatically controlling and limiting the vehicle speed. Furthermore, the regulating mechanism includes a microprocessor connected to the governor having control logic to determine whether the vehicle speed is above or below the predetermined threshold speed.

The microprocessor cooperates with the governor to automatically deactivate the magnetic clutch, stopping alternator operation when the vehicle speed drops below a predetermined speed. The microprocessor then reactivates the direct current mechanism for allowing current from the battery to enter one motor.

The present invention may further include a plurality of containers in fluid communication with the battery for collecting acid vapor byproduct emitted therefrom during operating conditions wherein the vehicle speed is above the predetermined threshold speed.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a top plan view showing an electrical motor hybrid system including associated electrical connections, in accordance with the present invention;

FIG. 2 is a schematic diagram showing the interrelationship of the system components shown in FIG. 1;

FIG. 3 is a partial internal view of the electrical and internal combustion motors shown in FIG. 1; and

FIG. 4 is an enlarged side elevational view of the system shown in FIG. 1 with the plurality of fastening members attached thereto.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

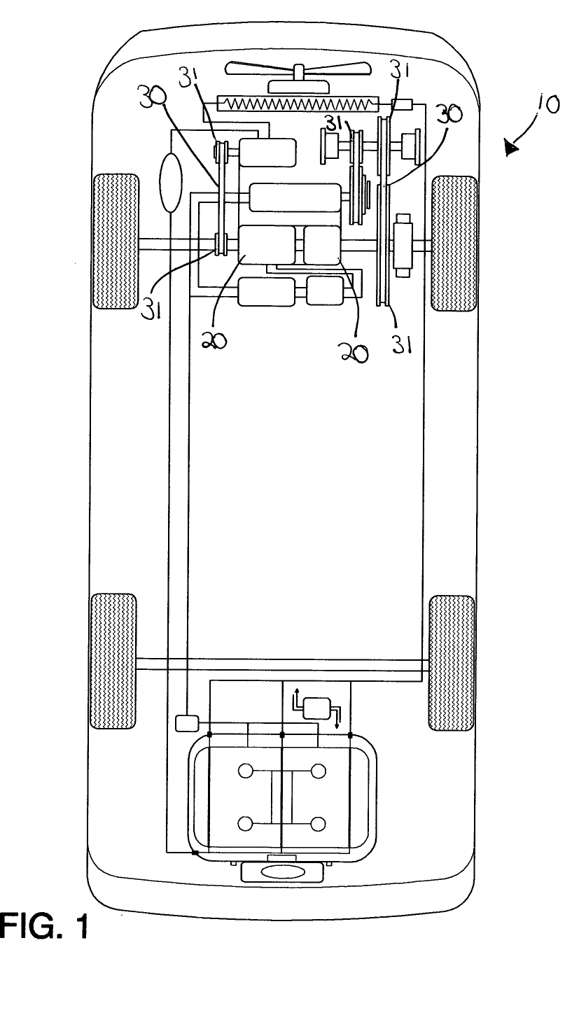

The system of this invention is referred to generally in FIGS. 1-4 by the reference numeral 10 and is intended to provide a hybrid car engine that automatically switches from low to high powered electric motors at a predetermined speed. It should be understood that the system 10 may be incorporated into a wide range of new production cars and light trucks.

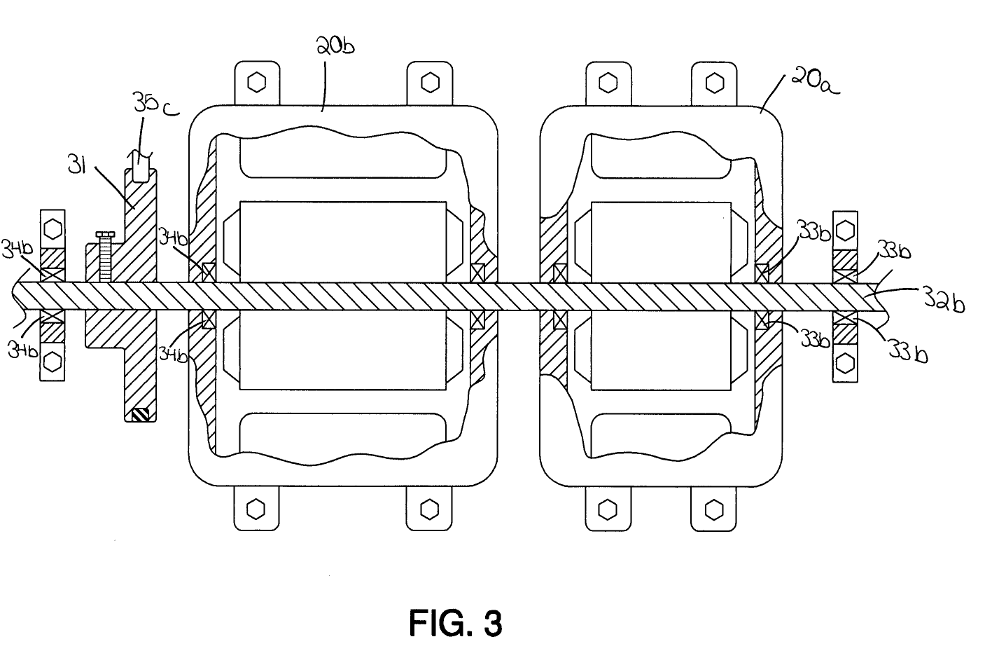

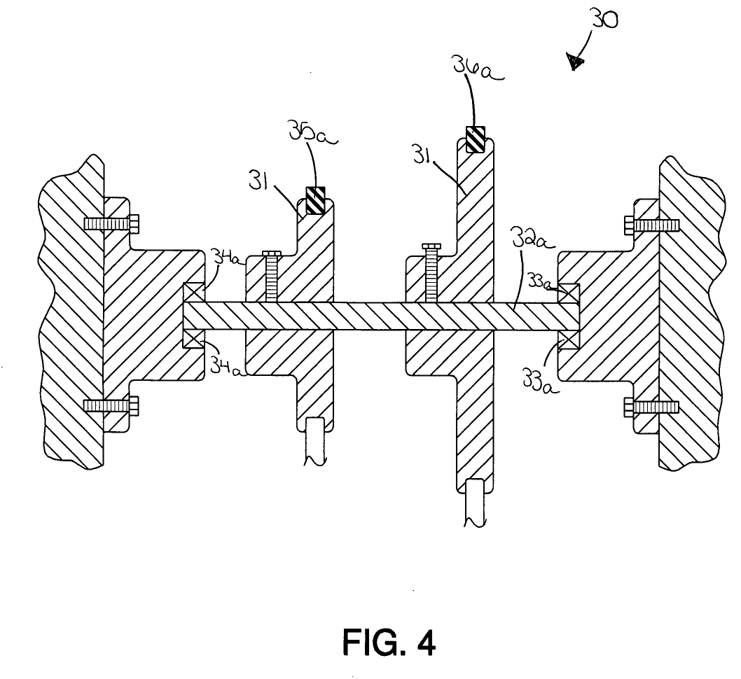

Referring initially to FIG. 1, the system 10 includes a plurality of in-line electric motors 20 including a plurality of cylinders (not shown) arranged along a rectilinear path operably connected to selected portions of the vehicle respectively. Referring to FIGS. 3 and 4, the present invention further includes a high-speed pulley system 30 including a plurality of pulleys 31 operably connected to the plurality of motors 20 respectively and contemporaneously rotatable at variable speeds during operating conditions. Such a system 30 includes drive shafts 32 traversing through pulleys 31. One draft shaft 32a has opposed end portions journaled with associated bearing members 33a, 34a wherein a pair of belts 35a, 36a are spaced being the shaft end portions and rotate thereabout in a predetermined radial path. Likewise, shaft 32b is similarly situated with associated bearings 33b, 34b and belt 35c cooperating therewith during operating conditions, as well known to a person of ordinary skill in the automobile industry.

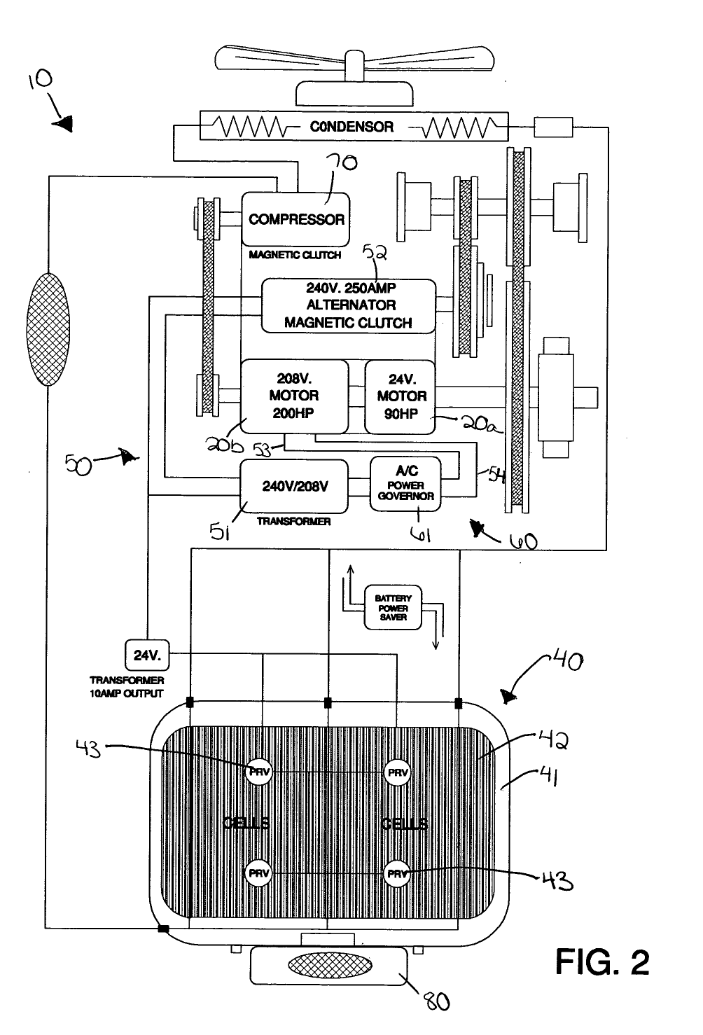

Now referring to FIG. 2, the present invention further includes a direct current mechanism 40 for supplying power and accelerating the vehicle by direct current when the vehicle is traveling below a predetermined threshold speed. Such a low-voltage mechanism 40 is connected to one motor 20a and includes a deep cycle battery 41 for supplying electric current to the system 10. The battery 41 includes a plurality of evaporator coils 42 traversing along therein and a plurality of pressure-relief valves 43 disposed adjacent the evaporator coils 42 wherein the pressure-relief valves 43 are caused to open when the battery 41 reaches a predetermined threshold pressure. While the deep-cycle battery 41 powers the DC motor 20a the drive wheel is rotating at two times the RPMS.

Advantageously, the present invention further includes an alternating current mechanism 50 for selectively supplying power and accelerating the vehicle when the vehicle is traveling above a predetermined threshold speed. Such an alternating current mechanism 50 is operably connected to another of the plurality of motors 20b. The alternating current mechanism 50 includes primary 53 and secondary 54 circuits for adjusting the current and voltage level of the system 10.

Referring to FIG. 2, the alternating current mechanism 50 preferably includes a high-energy variable-voltage transformer 51 employing mutual induction to convert variations of a first current in the primary circuit 53 into variations of a voltage and a second current in the secondary circuit 54. Furthermore, the alternating current mechanism further includes an alternator 52 for producing and sending alternating current from the transformer 51 to another of the plurality of motors 20b.

For example, from 0 to 40 miles per hour the vehicle is accelerated by the low powered motor 20a. This motor 20a is suitable for driving within city limits while the high-speed pulley system 30 and AC drive motor 20b is inactive. When the driver approaches highway speed, the high-speed pulley system 30 is activated automatically to power up the transformer 51 and deactivates the DC motor 20a. With sufficient power output from the AC transformer 51, the accelerator pedal, already depressed, automatically feeds AC current from the transformer 51 to the AC drive motor 20b.

The present invention further includes a mechanism for automatically regulating an operating mode of the system 10 so that the alternating current mechanism 50 is inactive when the direct current mechanism 40 is active and vice versa. Such a regulating mechanism 60 advantageously includes a governor 61 attached to the vehicle for automatically controlling and limiting the vehicle speed. Furthermore, the regulating mechanism 60 includes a microprocessor (not shown) connected to the governor 61 having control logic to determine whether the vehicle speed is above or below the predetermined threshold speed.

The microprocessor (not shown) cooperates with the governor 61 to automatically deactivate the magnetic clutch 70, stopping alternator 52 operation when the vehicle speed drops below a predetermined speed. The microprocessor (not shown) then reactivates the direct current mechanism 40 for allowing current from the battery 41 to enter one motor 20a.

Referring to FIG. 2, the present invention may further include a plurality of containers 80 in fluid communication with the battery 41 for collecting acid vapor byproduct emitted therefrom during operating conditions wherein the vehicle speed is above the predetermined threshold speed.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A electrical engine system for propelling a vehicle at variable speeds wherein the vehicle includes a magnetic clutch and a cooling fan provided with a condenser, said system comprising:
a plurality of in-line electric motors including a plurality of cylinders arranged along a rectilinear path and being operably connected to selected portions of the vehicle respectively;
a high-speed pulley system comprising a plurality of pulleys operably connected to said plurality of motors respectively and being contemporaneously rotatable at variable speeds during operating conditions;
direct current means for supplying power and accelerating the vehicle by direct current when the vehicle is traveling below a predetermined threshold speed, said low-voltage means being connected to one said plurality of motors;
alternating current means for selectively supplying power and accelerating the vehicle when the vehicle is traveling above a predetermined threshold speed, said alternating current means being operably connected to another said plurality of motors, said alternating current means including primary and secondary circuits for adjusting current and voltage level of said system; and
means for automatically regulating an operating mode of said system so that said alternating current means is inactive when said direct current means is active and vice versa.

2. The system of claim 1, wherein said direct current means comprises:
a deep cycle battery for supplying electric current to said system.

3. The system of claim 2, wherein said alternating current means comprises:
a high-energy variable-voltage transformer employing mutual induction to convert variations of a first current in the primary circuit into variations of a voltage and a second current in the secondary circuit.

4. The system of claim 3, wherein said alternating current means further comprises: an alternator for producing and sending alternating current from said transformer to said another motor.

5. The system of claim 4, wherein said regulating means comprises:
a governor attached to the vehicle for automatically controlling and limiting the vehicle speed; and
a microprocessor connected to said governor and having control logic for determining whether the vehicle speed is above or below the predetermined threshold speed, said microprocessor cooperating with said governor for automatically deactivating the magnetic clutch to stop the alternator from operating when the vehicle speed drops below the predetermined threshold speed, said microprocessor reactivating said direct current means for allowing current from said battery to enter said one motor.

6. The system of claim 2, further comprising: a plurality of containers in fluid communication with said battery and for collecting acid vapor byproduct emitted therefrom during operating conditions wherein the vehicle speed is above the predetermined threshold speed.

7. An electrical engine system for propelling a vehicle at variable speeds wherein the vehicle includes a magnetic clutch and a cooling fan provided with a condenser, said system comprising:
a plurality of in-line electric motors including a plurality of cylinders arranged along a rectilinear path and being operably connected to selected portions of the vehicle respectively;
a high-speed pulley system comprising a plurality of pulleys operably connected to said plurality of motors respectively and being contemporaneously rotatable at variable speeds during operating conditions;
direct current means for supplying power and accelerating the vehicle by direct current when the vehicle is traveling below a predetermined threshold speed, said low-voltage means being connected to one said plurality of motors, said direct current means comprising a deep cycle battery for supplying electric current to said system, said battery including a plurality of evaporator coils traversing along therein;
alternating current means for selectively supplying power and accelerating the vehicle when the vehicle is traveling above a predetermined threshold speed, said alternating current means being operably connected to another said plurality of motors, said alternating current means including primary and secondary circuits for adjusting current and voltage level of said system; and
means for automatically regulating an operating mode of said system so that said alternating current means is inactive when said direct current means is active and vice versa.

8. The system of claim 7, wherein said alternating current means comprises:
a high-energy variable-voltage transformer employing mutual induction to convert variations of a first current in the primary circuit into variations of a voltage and a second current in the secondary circuit.

9. The system of claim 8, wherein said alternating current means further comprises: an alternator for producing and sending alternating current from said transformer to said another motor.

10. The system of claim 9, wherein said regulating means comprises:
a governor attached to the vehicle for automatically controlling and limiting the vehicle speed; and
a microprocessor connected to said governor and having control logic for determining whether the vehicle speed is above or below the predetermined threshold speed, said microprocessor cooperating with said governor for automatically deactivating the magnetic clutch to stop the alternator from operating when the vehicle speed drops below the predetermined threshold speed, said microprocessor reactivating said direct current means for allowing current from said battery to enter said one motor.

11. The system of claim 7, further comprising: a plurality of containers in fluid communication with said battery and for collecting acid vapor byproduct emitted therefrom during operating conditions wherein the vehicle speed is above the predetermined threshold speed.

12. An electrical engine system for propelling a vehicle at variable speeds wherein the vehicle includes a magnetic clutch and a cooling fan provided with a condenser, said system comprising:
a plurality of in-line electric motors including a plurality of cylinders arranged along a rectilinear path and being operably connected to selected portions of the vehicle respectively;
a high-speed pulley system comprising a plurality of pulleys operably connected to said plurality of motors respectively and being contemporaneously rotatable at variable speeds during operating conditions;
direct current means for supplying power and accelerating the vehicle by direct current when the vehicle is traveling below a predetermined threshold speed, said low-voltage means being connected to one said plurality of motors, said direct current means comprising a deep cycle battery for supplying electric current to said system, said battery including a plurality of evaporator coils traversing along therein and further including a plurality of pressure-relief valves disposed adjacent said evaporator coils wherein said pressure-relief valves are caused to open when said battery reaches a predetermined threshold pressure;
alternating current means for selectively supplying power and accelerating the vehicle when the vehicle is traveling above a predetermined threshold speed, said alternating current means being operably connected to another said plurality of motors, said alternating current means including primary and secondary circuits for adjusting current and voltage level of said system; and
means for automatically regulating an operating mode of said system so that said alternating current means is inactive when said direct current means is active and vice versa.

13. The system of claim 12, wherein said alternating current means comprises:
a high-energy variable-voltage transformer employing mutual induction to convert variations of a first current in the primary circuit into variations of a voltage and a second current in the secondary circuit.

14. The system of claim 13, wherein said alternating current means further comprises: an alternator for producing and sending alternating current from said transformer to said another motor.

15. The system of claim 14, wherein said regulating means comprises:
a governor attached to the vehicle for automatically controlling and limiting the vehicle speed; and
a microprocessor connected to said governor and having control logic for determining whether the vehicle speed is above or below the predetermined threshold speed, said microprocessor cooperating with said governor for automatically deactivating the magnetic clutch to stop the alternator from operating when the vehicle speed drops below the predetermined threshold speed, said microprocessor reactivating said direct current means for allowing current from said battery to enter said one motor.

16. The system of claim 12, further comprising: a plurality of containers in fluid communication with said battery and for collecting acid vapor byproduct emitted therefrom during operating conditions wherein the vehicle speed is above the predetermined threshold speed.
